(19) United States
(12) Patent Application Publication
(10) Pub. No.: US 2026/0358197 A1
(43) Pub. Date: Nov. 12, 2026

(54) ENGINE OIL OVERFILL DETECTION SYSTEM

(71) Applicant: Caterpillar Inc., Peoria, IL (US)

(72) Inventors: Brandon Dykstra, Lafayette, TN (US); Zaid Siddiqi, Peoria, IL (US); Daniel Reprieto, Tucson, AZ (US); Aaron M. Dill, Zionsville, IN (US); Michael J. Campagna, Chillicothe, IL (US)

(73) Assignee: Caterpillar Inc., Peoria, IL (US)

(21) Appl. No.: 19/199,492

(22) Filed: May 6, 2025

(51) Int. Cl. G01M 15/05

(52) U.S. Cl. CPC G01M 15/05

(57) ABSTRACT

An engine oil overfill detection system includes an internal combustion engine, a generator connected to the internal combustion engine for generating electrical power, and a power sensor configured to generate a signal indicative of an amount of the electrical power from the generator. The engine oil overfill detection system also includes a pressure sensor configured to generate a signal indicative of pressure within a crankcase of the internal combustion engine and a controller configured to: receive the signal from the power sensor, receive the signal from the pressure sensor, and determine that an oil overfill condition exists based on at least one of the signal from the power sensor or the signal from the pressure sensor.

### TECHNICAL FIELD

The present disclosure relates generally to an engine system, and, more particularly, to a system configured to detect engine oil overfills.

### BACKGROUND

Internal combustion engines are generally reliable systems that are used in many different applications. Engine systems are used, for example, to create mechanical energy for generating electrical power. These electrical power generation systems can include the internal combustion engine itself as well as a generator mechanically coupled to the engine. These engine and generator systems are used to generate electrical power for mobile machines (e.g., machines with electric drives, machines with hybrid drivetrains, etc.), in off-grid applications (e.g., oil fields, mines, construction sites, marine systems, etc.), and in other systems.

Power generating systems operate for long periods of time under consistent high-load conditions to reliably generate power. The internal combustion engine of these systems typically consumes oil over time. Oil is periodically added to the engine and also changed at periodic service intervals. The addition of an excessive amount of lubricating oil can result in generation of a reduced amount of power for a period of time due to increased resistance, reducing efficiency and potentially placing components of the power generating system under strain.

CN 114991606 B, issued on Jan. 5, 2024 (“the '606 patent”), describes a device for monitoring engine oil. The device described in the '606 patent can calculate an oil level height based on vehicle acceleration, inclination angle, operating time, engine speed, and oil pressure information. An oil quantity value is compared with a preset oil quantity threshold value to determine when the level of oil has reached a dangerous condition. The engine oil amount monitoring device described in the '606 patent is not capable of identifying an engine oil overfill condition, such as an overfill condition detected according to power output via an internal combustion engine.

The system and method of the present disclosure may solve one or more of the problems set forth above and/or other problems in the art. The scope of the current disclosure, however, is defined by the attached claims, and not by the ability to solve any specific problem.

### SUMMARY

In one aspect, an engine oil overfill detection system may include an internal combustion engine, a generator connected to the internal combustion engine for generating electrical power, and a power sensor configured to generate a signal indicative of an amount of the electrical power from the generator. The engine oil overfill detection system may also include a pressure sensor configured to generate a signal indicative of pressure within a crankcase of the internal combustion engine and a controller configured to: receive the signal from the power sensor, receive the signal from the pressure sensor, and determine that an oil overfill condition exists based on at least one of the signal from the power sensor or the signal from the pressure sensor.

In another aspect, an engine oil overfill detection system may include a power sensor configured to generate a signal indicative of an amount of an electrical power from a generator, a pressure sensor configured to detect a pressure of lubricating oil for an internal combustion engine, and a controller. The controller may be configured to receive the signal from the power sensor, receive the signal from the pressure sensor, and determine that an excessive oil condition exists when the signal from the power sensor indicates that power has dropped by at least a power change threshold.

In yet another aspect, a method for detecting an engine oil overfill condition may include receiving pressure data from a pressure sensor, receiving power data from a generator power sensor, comparing the pressure data to prior pressure data, comparing the power data to prior power data, and determining that the pressure data and the power data indicate an engine oil overfill based on comparing the pressure data to the prior pressure data and comparing the power data to the prior power data.

### BRIEF DESCRIPTION OF THE DRAWINGS

The accompanying drawings, which are incorporated in and constitute a part of this specification, illustrate various exemplary aspects of the disclosure, and, together with the description, explain principles of the disclosure.

FIG. 1 is a schematic side view of a machine having an engine oil overfill detection system, in accordance with the present disclosure.

FIG. 2 is a block diagram of a controller for the engine oil overfill detection system shown in FIG. 1.

FIG. 3 is a flowchart illustrating an example of a method for engine oil overfill detection.

FIG. 4 is a diagram showing crankcase pressure and power signals for the engine oil overfill detection system shown in FIG. 1.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value. As used herein, “based on” encompasses “based, at least in part, on” unless explicitly stated otherwise.

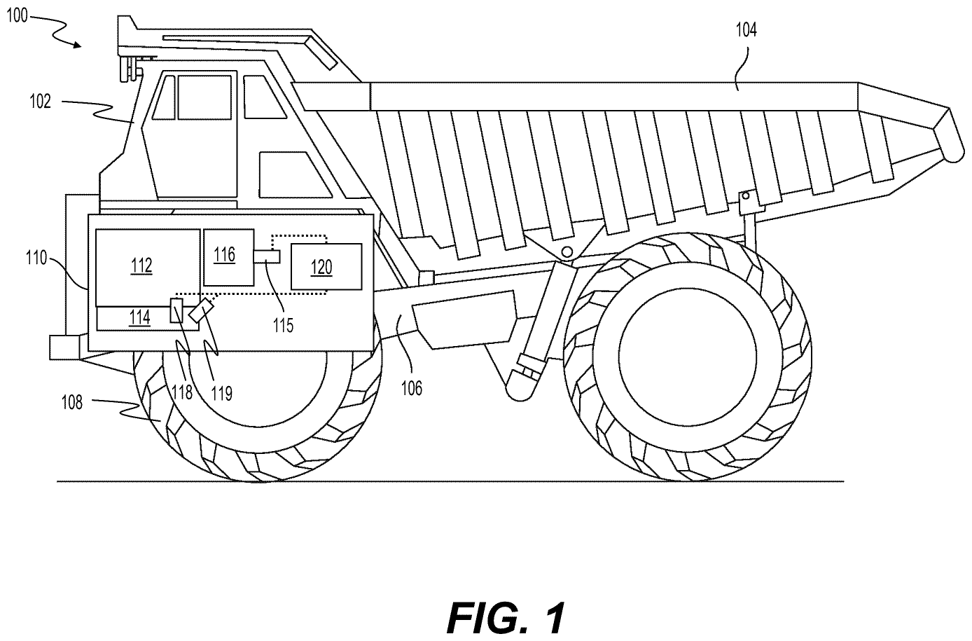

FIG. 1 is a schematic side view of a machine system 100 that includes a machine 102 and an engine oil overfill detection system 110. Machine 102 may be a mobile or stationary machine, with a haul truck being shown in the example illustrated in FIG. 1. The haul truck machine 102 includes a dump body 104, a chassis or frame 106 supporting dump body 104 and an operator cab, and propulsion devices 108 such as wheels or tracks. Engine oil overfill detection system 110 may include an internal combustion engine 112 having a crankcase 114, a generator 116, a crankcase pressure sensor 118, an oil level sensor 119, an oil pressure sensor (not shown), and an oil overfill detection controller 120.

Internal combustion engine 112 may be part of an electrical power generating system (e.g., an electric drive) that also includes generator 116. Generator 116 is mechanically coupled to engine 112 and configured to generate electrical energy during operation of internal combustion engine 112. An oil sump of internal combustion engine 112 may be located at the bottom of crankcase 114 for circulating oil throughout internal combustion engine 112 via an oil pump (not shown). Crankcase 114 may be configured with open crankcase ventilation or closed crankcase ventilation systems. Crankcase pressure sensor 118 may be configured to detect a pressure of air within crankcase 114 whether crankcase 114 is configured for open crankcase ventilation or closed crankcase ventilation.

As shown in FIG. 1, some embodiments of machine system 100 include oil level sensor 119. Oil level sensor 119 may be shaped similarly to an engine oil dipstick to be positioned within a dipstick tube of engine 112. Oil level sensor 119 may be an electronic (e.g., digital) oil level sensor that is configured to detect changes in the current level of oil. These measurements may be measured on a continuous basis such that is capable of measuring multiple different levels of fluid (e.g., by using capacitance). At least some of the oil levels that sensor 119 is capable of detecting may be in a region that indicates an oil overfill event. Measurements on this portion of sensor 119 may be referred to as measurements in an “overfill region” and represent a level of oil that is above the level of oil associated with a maximum quantity of oil that should be supplied for engine 112.

Oil overfill detection controller 120 may be in communication with a power sensor 115 and crankcase pressure sensor 118. Power sensor 115 may be configured to detect electrical power output from generator 116. Power sensor 115 may include, for example, a voltage sensor, a current sensor, etc. Power sensor 115 may be implemented as circuitry internal to generator 116 or as one or more external sensors (e.g., clamp sensors). Crankcase pressure sensor 118 may be located at any position which allows crankcase pressure sensor 118 to output signals that correspond to the air pressure in crankcase 114. Oil overfill detection controller 120 may be configured to receive signals from power sensor 115 and crankcase pressure sensor 118.

Oil overfill detection controller 120 may be an electronic controller or electronic control module that monitors or controls one or more aspects of machine system 100, and may be configured to identify an engine oil overfill condition based on the pressure of air within crankcase 114 and the amount of power output from generator 116. In some aspects, oil overfill detection controller 120 may also take into account a level of oil measured with oil level sensor 119. Detection controller 120 may be implemented as part of a larger control unit (e.g., a system that controls multiple aspects of system 100) or a controller that is dedicated to monitoring oil overfill conditions. In some configurations, detection controller 120 is implemented via multiple controllers, the phrase “controller” encompassing both single and multiple physical devices. Detection controller 120 may be enabled, via programming, to generate notifications or issue commands that are associated with an engine oil overfill condition, including notifications or commands that are generated based on determining that an excessive amount of oil is present in system 110. In particular, detection controller 120 may be configured to generate a notification for a remote system (e.g., a system at a different physical location than system 100) that indicates an engine overfill condition (e.g., via a notification that expresses a need to reduce the quantity of oil present in system 110).

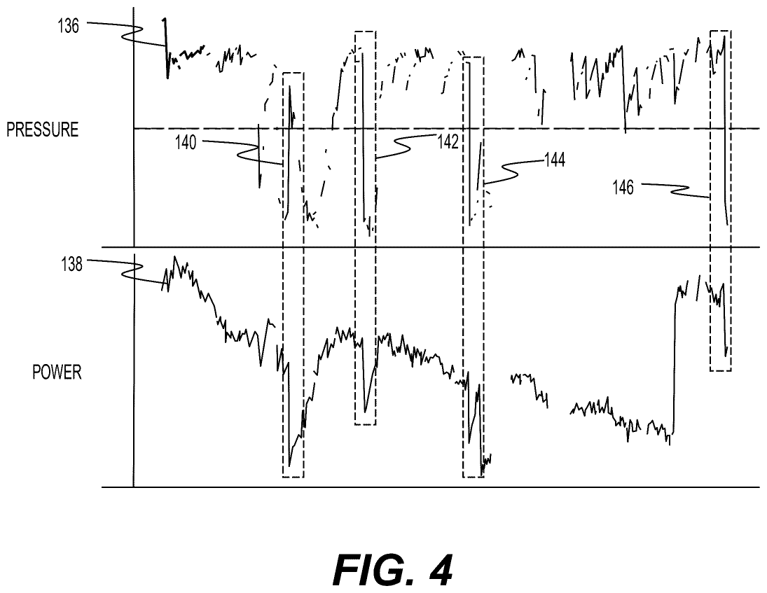

Detection controller 120 may embody a single microprocessor or multiple microprocessors that receive inputs and generate outputs. Detection controller 120 may include a memory, a secondary storage device, a processor such as a central processing unit, or any other means for accomplishing a task consistent with the present disclosure. The memory or secondary storage device associated with detection controller 120 may store data and software to allow detection controller 120 to perform its functions, including the functions described with respect to method 145 (FIG. 4), described below. Numerous commercially available microprocessors can be configured to perform the functions of detection controller 120. Various other known circuits may be associated with detection controller 120, including signal receiving circuitry, signal-conditioning circuitry, communication circuitry, display control circuitry, power-source command circuitry, and other appropriate circuitry. Detection controller 120 may include circuitry for identifying an engine oil overfill condition based on air pressure within a crankcase and electrical power signals and circuitry for generating a notification based on the engine oil overfill condition, as described below.

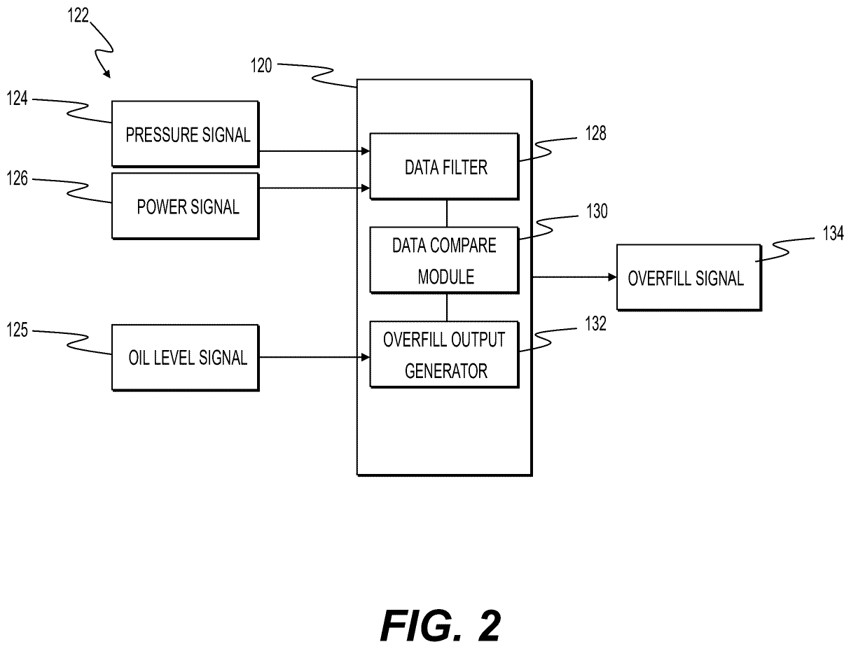

FIG. 2 is a block diagram of an exemplary configuration of detection controller 120. As shown, detection controller 120 may receive inputs 122, including pressure signals 124 from crankcase pressure sensor 118, and power signals 126 from power sensor 115. Inputs 122 may also include oil level signals 125 from level sensor 119, if desired. Oil level signals 125 may be received by overfill output generator 132. Detection controller 120 may be configured to generate one or multiple outputs, including overfill signal 134.

Detection controller 120 may include a data filter 128, a compare module 130, and an overfill output generator 132. Data filter 128 may be configured to receive pressure signals 124 and power signals 126 during operation of internal combustion engine 112 (FIG. 1). Pressure signals 124 may include data representative of the pressure of air within crankcase 114. Pressure signals 124 may be received with data filter 128 from crankcase pressure sensor 118 during operation of internal combustion engine 112. Power signals 126 may include data that indicates an amount of electrical power output from generator 116. Power signals 126 may be received with data filter 128 from power sensor 115 during operation of generator 116.

Data filter 128 may perform operations to filter (e.g., select) data from pressure signals 124 that is representative of pressure within crankcase 114 over a period of time. The period of time may be, for example, equal to at least 10 minutes, 1 hour, 4 hours, 8 hours, 1 day, 2 days, etc. Data filter 128 may also perform operations to filter data of power signals 126 that is representative of generated power over the same period of time. Data filter 128 may be configured to identify pressure data and power data that is generated by sensors 115 and 118 when internal combustion engine 112 and generator 116 operate under steady state conditions. Steady state conditions may include, for example, engine speed being above a minimum speed and below a maximum speed, load factor being above a minimum load factor value, an engine derate value being less than a maximum derate value, and fuel rate for the internal combustion engine being greater than a minimum fuel rate value.

In some aspects, data filter 128 may output pressure data and power data that represents the average crankcase pressure and average power for the above-described period of time. The average pressure and average power may represent the mathematical average or other representative value that corresponds to engine and generator conditions for the period of time (e.g., one day or one of the other periods of time described above). The average may be taken based entirely on measurements that are taken while engine 112 operates under steady state conditions.

Compare module 130 may receive filtered data from data filter 128. In the example where the period of time is one day, data filter 128 may output a daily pressure value and a daily power value, these values being output each day that system 100 is operated for a period of time sufficient to reach steady state conditions or otherwise generate accurate data. Data compare module 130 may store each point of data and monitor changes to the daily pressure value and the daily power value over time.

In one example, data compare module 130 may, upon receipt of a daily crankcase pressure value, compare this daily pressure value to the prior pressure value. The “prior” pressure value may be the pressure value from the most-recent period of time, such as the prior day. Compare module 130 may determine a magnitude of the difference between the daily pressure value and the prior pressure value, this difference also referred to herein as an “pressure change value.”

In situations where the prior crankcase pressure value is not available (e.g., the period of time is one day and the system was not operated in the prior day), compare module 130 may compare the daily pressure value to a recent pressure value. The “recent” pressure value may be a crankcase pressure value from a period of time other than the most-recent period of time. When the period of time is one day, a recent pressure value may be retrieved from a day that occurred within seven days, within five days, within three days, or within two days. The difference between the daily pressure value and the recent pressure value may be used by compare module 130 to determine the pressure change value.

Compare module 130 may be configured to compare the daily power value to a prior power value or a recent power value in a manner that corresponds to the daily pressure value. Compare module 130 may, based on this comparison, determine a magnitude of the difference between the daily power value and the prior power value, this difference also referred to herein as a “power change value.” The power change value may also be determined by comparing the daily power value to a recent power value (e.g., an earlier power value received within seven days, within five days, within three days, or within two days of the daily power value).

Overfill output generator 132 may receive the pressure change value and the power change value. The pressure change value may be compared to a pressure change threshold value (e.g., a value that is set based on pressure increases and decreases that tend to occur to air within crankcase 114 when oil is overfilled). Overfill output generator 132 may determine that an engine overfill condition exists when the pressure change value is greater than the pressure change threshold value. In some aspects, a single pressure change threshold value may be used for comparison to increases in pressure and also for decreases in pressure. In other aspects, different pressure change threshold values, such as a pressure increase threshold and pressure drop threshold, may be used for comparison to increases in pressure and for decreases in pressure, respectively.

In response to this determination, overfill output generator 132 may generate overfill signal 134. In response to determining that the oil change value is less than the pressure change threshold value, overfill output generator 132 may determine that no engine oil overfill condition exists.

Overfill output generator 132 may determine whether the power change value indicates a positive power change that corresponds to an increase in power, or a negative power change that corresponds to a decrease in power. When the power change value indicates a decrease in power, overfill output generator 132 may compare the power change value to a power change threshold value (e.g., a value that is set based on power decreases that tend to occur when oil is overfilled, due to increased resistance of components of engine 112 to motion). Overfill output generator 132 may determine that an engine overfill condition exists when the power change value is greater than the power change threshold value. When the power change value indicates an increase in power, or when the power change value is less than the power change threshold value, overfill output generator 132 may determine that no engine oil overfill condition exists.

In some configurations, overfill output generator 132 may determine that an engine oil overfill condition exists only when the power change value exceeds the power change threshold value and the pressure change value exceeds the pressure change threshold value. In other configurations, overfill output generator 132 may determine the engine oil overfill condition when only one of the change values exceeds the corresponding threshold value.

In some configurations, when the power pressure change value or the pressure change value indicates an engine overfill condition, as described above, overfill output generator 132 may confirm the overfill condition based on the oil level indicated by oil level signal 125 for the same period of time (e.g., due to oil being detected in the overfill region of sensor 119). In some aspects, overfill signal 134 indicating an overfill is only output by generator 132 when oil level signal 125 from sensor 119 also indicates an overfill condition. If desired, overfill output generator 132 may determine that an overfill condition does not exist, or require additional measurements to confirm an overfill condition, when oil level signal 125 from sensor 119 does not indicate an oil overfill condition (e.g., due to no oil detection in the sensor's overfill region).

When overfill output generator 132 determines that an engine oil overfill condition exists overfill output generator 132 may generate an overfill signal 134 to cause an indication (e.g., an audio, visual, or tactile notification) that too much oil has been supplied to internal combustion engine 112. This overfill signal 134 may be presented on a device (e.g., a display, light, or speaker) connected to machine system 100, such as a device within a cabin of machine 102. Overfill signal 134 may also be transmitted to a mobile device, such as a cell phone, that is in communication with machine system 100. Overfill signal 134 may also be transmitted to a remote (e.g., off-site) supervisory system that monitors multiple machine system 100.

While the example discussed above includes an oil level sensor 119, in at least some embodiments, no oil level sensor is connected to internal combustion engine 112 or present in machine system 100. Additionally, in some configurations where an oil level sensor is present, the oil level sensor is not used for detection of engine oil overfills.

### Industrial Applicability

Machine system 100 and engine oil overfill detection system 110 may be applied to any engine system that includes a fluid-lubricated internal combustion engine that acts as a prime mover for an electric machine such as a generator. Engine oil overfill detection system 110 may be provided as part of a machine system 100 for mobile machines such as haul trucks, earthmoving machines, paving machines, marine systems, and other systems requiring electric power.

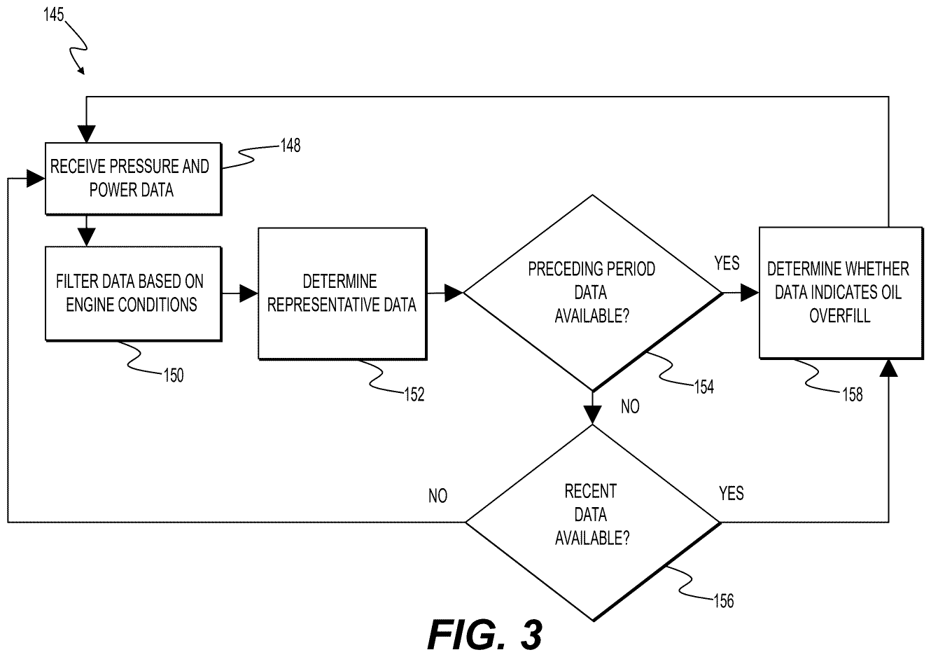

FIG. 3 illustrates a flowchart of an exemplary method 145 for detecting an engine oil overfill condition. FIG. 4 illustrates exemplary pressure values and power values as a function of time.

A step 148 of method 145 may include receiving pressure data and power data, such as pressure signals 124 and power signals 126 received with data filter 128 of detection controller 120 (FIG. 2). Step 148 may include data received during operation of internal combustion engine 112 and generator 116.

A step 150 may include filtering the pressure and power data received in step 148. Step 150 may include filtering pressure and power data with data filter 128 by selecting data that was measured when internal combustion engine 112 was operating under in the above-described steady state condition. Filtering in step 150 may include removing or ignoring measurements from sensors 115 and 118 that were received when one or more conditions associated with steady state operation is not satisfied.

A step 152 may include determining representative data with data filter 128. This representative data may be, for example, a daily pressure value and a daily power value determined with data filter 128 from data filtered in step 150. Representative data values may be formed by averaging data filtered in step 150 that was received over a particular period of time, such as one day in the example of determining a daily pressure value or daily power value.

A step 154 may include determining if representative data, such as a daily pressure value or a daily power value, is available from the prior period of time. The prior period may be the period immediately preceding, the most-recent preceding period of time that corresponds to the representative data determined in step 152. For example, when the representative data is a daily pressure value or a daily power value, the prior period may correspond to the daily pressure or daily power from the immediately preceding day.

When data from the prior period is available, a step 158 may be performed with this prior period data. However, when data from the prior period is not available, a step 156 may be performed. Step 156 may include determining whether recent data is available. Recent data may include representative data from an earlier period of time that is within a predetermined recency period (e.g., two days, three days, etc.). When recent data is available, step 158 may be performed with this recent data. When no recent data is available, method 145 may return to step 148.

In step 158, representative data from a first (e.g., current) period of time may be compared by compare module 130 (FIG. 2) to either prior period data identified in step 154 or recent data identified in step 156. Step 158 may include determining a power change value or a pressure change value with compare module 130, as described above.

A step 160 may also include generating a notification, such as overfill signal 134, when compare module 130 determines in step 158 that the power change value exceeds a power change threshold value or when the pressure change value exceeds a pressure change threshold value, indicating an excessive oil condition. In some embodiments, step 160 may include generating overfill signal 134 when compare module 130 determined that both: the power change value exceeds the power change threshold value and the pressure change value exceeds the pressure change threshold value.

FIG. 4 is a chart with a graphical representation of pressure values and power values over time. Periods of time (e.g., days) where machine system 100 was not operated are represented by portions of FIG. 4 that do not contain filtered pressure data 136 or filtered power data 138.

Filtered pressure data 136 represents a series of pressure values that have been filtered with data filter 128. Each point of filtered pressure data 136 corresponds to data collected while internal combustion engine 112 was operating at steady state. Each point of data 136 may be representative data, such as data measured over a particular period of time (e.g., one day) and processed (e.g., by taking the average or mean of measurements taken over the period of time). Gaps in the plot of pressure data 136 represent days in which system 100 was not operated, or days in which steady state was not achieved.

Filtered power data 138 represents power measurements (e.g., an amount of kW). Each point of data 138 corresponds to a point of data 136 located at the same point along the x-axis of FIG. 4. Filtered power data 138 may represent a series of power values that have been filtered with data filter 128. Data 138 may also include representative data measured over a particular period of time, each point of data 138 being a daily average power value, for example.

FIG. 4 illustrates four exemplary events identified with detection controller 120: event 140, event 142, event 144, and event 146. Each event 140, 142, 144, and 146 corresponds to an engine oil overfill when an excessive quantity of oil was supplied to crankcase 114 (FIG. 1). As shown in FIG. 4, event 140 corresponds to a rapid increase in crankcase pressure while events 142, 144, and 146 are each associated with a rapid decrease in pressure, an increase or decrease in pressure being associated with an oil overfill condition. Filtered power data 138 shows that events 140, 142, 144, and 146 are each associated with a decrease in output power.

The disclosed system and method may allow identification of engine oil overfill conditions. Engine oil overfill may be identified based on pressure and generator power, facilitating prompt action and improving power output. The system and method may result in increased engine power, decreased fuel consumption, and decreased engine oil aeration over time. The oil overfill condition can be identified based on crankcase pressure, power output from a generator, or both, improving the accuracy in which an overfill condition is identified. The ability to generate in-cabin or remote notifications can reinforce correct oil refill practices and improve the performance of maintenance personnel.

It will be apparent to those skilled in the art that various modifications and variations can be made to the disclosed system and method without departing from the scope of the disclosure. Other embodiments of the system and method will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

What is claimed is:

1. An engine oil overfill detection system, the system comprising:
an internal combustion engine;
a generator connected to the internal combustion engine for generating electrical power;
a power sensor configured to generate a signal indicative of an amount of the electrical power from the generator;
a pressure sensor configured to generate a signal indicative of pressure within a crankcase of the internal combustion engine; and
a controller configured to:
receive the signal from the power sensor,
receive the signal from the pressure sensor, and
determine that an oil overfill condition exists based on at least one of the signal from the power sensor or the signal from the pressure sensor.

2. The engine oil overfill detection system of claim 1, wherein the pressure sensor is connected to a crankcase of the internal combustion engine.

3. The engine oil overfill detection system of claim 1, wherein the controller is further configured to determine than the oil overfill condition exists by comparing an output power value to a prior output power value.

4. The engine oil overfill detection system of claim 3, wherein the output power value represents an average amount of power output from the generator over a period of time.

5. The engine oil overfill detection system of claim 1, further including an oil level sensor that is configured to detect a level of oil, the controller being further configured to determine that the oil overfill condition exists based on the detected level of oil.

6. The engine oil overfill detection system of claim 3, wherein the output power value corresponds to power that is generated during engine conditions that include one or more of:
engine speed being above a minimum speed or below a maximum speed, load factor being above a minimum load factor value, an engine derate value being less than a maximum derate value, or fuel rate for the internal combustion engine being greater than a minimum fuel rate value.

7. The engine oil overfill detection system of claim 1, wherein the signal from the pressure sensor indicates a decrease in pressure.

8. The engine oil overfill detection system of claim 1, wherein the signal from the pressure sensor indicates a decrease in pressure while the signal from the power sensor indicates a decrease in the amount of electrical power.

9. An engine oil overfill detection system, comprising:
a power sensor configured to generate a signal indicative of an amount of an electrical power from a generator;
a pressure sensor configured to detect a pressure of lubricating oil for an internal combustion engine; and
a controller configured to:
receive the signal from the power sensor,
receive the signal from the pressure sensor, and
determine that an excessive oil condition exists when the signal from the power sensor indicates that power has dropped by at least a power change threshold.

10. The engine oil overfill detection system of claim 9, wherein the controller is configured to determine that the excessive oil condition exists when the signal from the power sensor indicates that power has dropped by at least the power change threshold during a period of time in which the signal from the pressure sensor indicates that pressure has changed by at least a pressure change threshold.

11. The engine oil overfill detection system of claim 9, wherein the controller is configured to determine that the excessive oil condition exists when the signal from the power sensor indicates that power has dropped by at least the power change threshold during a period of time in which the signal from the pressure sensor indicates that pressure has dropped by at least a pressure drop threshold.

12. The engine oil overfill detection system of claim 11, wherein a magnitude of the drop in pressure is determined based on at least one prior pressure measurement.

13. The engine oil overfill detection system of claim 9, wherein a magnitude of the drop in power is determined based on at least one prior power measurement.

14. The engine oil overfill detection system of claim 9, wherein the controller is further configured to determine that the excessive oil condition exists based on a measurement from an oil level sensor configured to measure a presence of oil in an overfill region of the oil level sensor.

15. The engine oil overfill detection system of claim 9, wherein the controller is configured to determine that the excessive oil condition exists based on power sensor and pressure sensor measurements that are made when the internal combustion engine operates in a steady state condition.

16. The engine oil overfill detection system of claim 9, wherein the controller is further configured to generate a notification for displaying an indication of the excessive oil condition on a supervisory system located remotely from the internal combustion engine.

17. A method for detecting an engine oil overfill condition, the method comprising:
receiving pressure data from a pressure sensor;
receiving power data from a generator power sensor;
comparing the pressure data to prior pressure data;
comparing the power data to prior power data; and
determining that the pressure data and the power data indicate an engine oil overfill based on comparing the pressure data to the prior pressure data and comparing the power data to the prior power data.

18. The method of claim 17, wherein comparing the power data to prior power data is performed after determining that prior power data associated with operation during an immediately preceding period of operation is available or after determining that prior power data associated with operation during a recent period of operation is available.

19. The method of claim 18, wherein the immediately preceding period of operation corresponds to operation within 24 hours of the determination that the pressure data and the power data indicate the engine oil overfill.

20. The method of claim 18, wherein the recent period of operation corresponds to operation within seven days of the determination that the pressure data and the power data indicate the engine oil overfill.
